(19) United States
(12) Patent Application Publication
(10) Pub. No.: US 2025/0198091 A1
(43) Pub. Date: Jun. 19, 2025

(54) EXPANDABLE MEMBER FOR RECEPTACLE MOULDING

(71) Applicant: Pulpex Limited, Sawston, Cambridgeshire (GB)

(72) Inventor: Jason John WHITE, Southampton, Hampshire (GB)

(21) Appl. No.: 18/986,544

(22) Filed: Dec. 18, 2024

Related U.S. Application Data
(63) Continuation of application No. PCT/GB2023/051695, filed on Jun. 29, 2023.

(30) Foreign Application Priority Data
Jun. 30, 2022 (GB) 2209680.4

(51) Int. Cl. D21J 3/10

(52) U.S. Cl. CPC D21J 3/10

(57) ABSTRACT

An expandable member for use in moulding a receptacle in a cavity of a mould includes a neck portion and a main body portion. The neck portion defines an opening of the expandable member, and has a first width. The main body portion has a second width different to the first width, and has a wall having a thickness that varies along a length of the wall.

### CROSS-REFERENCE TO RELATED APPLICATIONS

This application is a continuation under 35 U.S.C. § 120 of International Application No. PCT/GB2023/051695, filed Jun. 29, 2023, which claims priority to United Kingdom Application No. GB 2209680.4, filed Jun. 30, 2022 under 35 U.S.C. § 119 (a). Each of the above-referenced patent applications is incorporated by reference in its entirety.

### TECHNICAL FIELD

The present invention relates to methods and systems of forming moulded receptacles from a fibre suspension, such as a fibre suspension comprising paper pulp, along with expandable members used in such methods and systems. The receptacles may form consumer packaging, such as bottles, useful for holding liquids, powders, other flowable materials or solid objects.

### BACKGROUND

It is desirable to reduce plastics use in consumable items, particularly packaging. Trays and other simple shapes are commonly made from paper pulp, but more complex objects, such as bottles, are more difficult to engineer.

For example, it may be difficult to ensure compaction of paper pulp within a mould to form a bottle with sufficient wall thickness and strength.

### SUMMARY

According to a first aspect of the present invention, there is provided an expandable member for use in moulding a receptacle in a cavity of a mould, the expandable member comprising: a neck portion defining an opening of the expandable member, the neck portion having a first width; and a main body portion having a second width different to the first width; wherein the main body portion comprises a wall having a thickness that varies along a length of the wall.

As the main body portion has a wall having a thickness that varies along a length of the wall, expansion of the main body portion of the expandable member may be controlled. For example, thinner regions of the wall may expand in preference to thicker regions of the wall. Therefore, by varying the thickness of the wall of the main body portion, contact of the main body portion with the receptacle upon expansion of the expandable member may be controlled. Such control of contact may facilitate moulding of the receptacle.

In particular, contact points of the expandable member with a receptacle may, as a result of friction, impact upon subsequent expansion of the expandable member within the receptacle. Thus, by controlling which region of the main body portion of the expandable member contacts the receptacle first, subsequent expansion and contact points of the expandable member may be controlled. This may ensure that the expandable member is able to contact particular regions of the receptacle with sufficient pressure to ensure sufficient compaction of the material from which the receptacle is made. The expandable member may thereby provide receptacles with more uniform strength when compared with, for example, receptacles formed by use of an expandable member having a main body portion of constant thickness.

Widths as discussed herein may comprise maximal widths between two opposing points on an outer surface of a relevant portion of the expandable member. Widths as discussed herein may comprise widths as measured when the expandable member is supported with the opening exposed to ambient external atmosphere, for example with substantially no radially inward or outward pressure applied to the expandable member.

Optionally, the thickness of the wall varies gradually along the length of the wall. This may provide more desirable expansion characteristics than, for example, a wall having one or more discrete changes or step-changes in thickness along its length.

Optionally, the thickness of the wall varies constantly along the length of the wall, for example with no step-changes in thickness. Optionally, the thickness of the wall tapers along the length of the wall, for example along substantially the entirety of the length of the wall.

Optionally, the main body portion comprises a shoulder portion proximal to the neck portion and a lower portion distal from the neck portion, the shoulder portion having a first wall thickness, the lower portion having a second wall thickness greater than the first wall thickness. By having a relatively thin shoulder portion and a relatively thick lower portion, contact of the main body of the expandable member with a receptacle, upon expansion of the expandable member, may be controlled such that the shoulder portion contacts the receptacle before the lower portion. Friction may then lock the shoulder portion in place relative to the receptacle, with the rest of the main body portion of the expandable member then expanding to fill and make contact with the receptacle.

Optionally, the second wall thickness is between 1.2 and 2.0 times the first wall thickness. Such a ratio may provide desirable expansion characteristics of the expandable member whilst ensuring that the thickness of the main body portion does not vary to too great a degree. This may, for example, facilitate manufacturing of the expandable member.

Optionally, the second wall thickness is between 1.4 and 1.8 times the first wall thickness. Optionally, the second wall thickness is around 1.6 times the first wall thickness.

Optionally, the first wall thickness is in the region of 1.2 mm to 4.0 mm. Optionally, the first wall thickness is in the region of 1.5 mm to 3.0 mm. Optionally, the first wall thickness is in the region of 2.7 mm.

Optionally, the second wall thickness is in the region of 1.7 mm to 7.2 mm. Optionally, the second wall thickness is in the region of 2.1 mm to 5.4 mm. Optionally, the second wall thickness is in the region of 4.4 mm.

Optionally, the neck portion comprises a further wall portion having a further wall thickness greater than a maximal wall thickness of the wall of the main body portion. By having a relatively thick further wall portion of the neck portion in comparison with the wall of the main body portion, increased strength may be provided in the region of the opening of the expandable member, for example in a region where the expandable member is connectable to an expansion fluid source in use. A relatively thick further wall portion of the neck portion in comparison with the wall of the main body portion may also encourage expansion of the main body portion in preference to the neck portion. This may be beneficial where, for example, the main body portion has a width greater than the neck portion.

Optionally, the second width is greater than the first width. Optionally, the second width is a maximal width of the main body portion. Optionally, a width of the main body portion varies along its length. Optionally, a minimal width of the main body portion occurs adjacent to the neck portion. Optionally, the second width is remote from the base portion, for example closer to the neck portion than to the base portion. Optionally, the second width occurs at an interface between the shoulder portion and the lower portion, when present. Optionally, the shoulder portion increases in width between the neck portion and the lower portion.

Optionally, the second wall thickness is the maximal wall thickness of the main body portion.

Optionally, the further wall thickness is between 1.1 and 1.5 times the second wall thickness. Optionally, the second wall thickness is around 1.2 times the first wall thickness.

Optionally, the further wall thickness is in the region of 3.1 mm to 10.8 mm. Optionally, the second wall thickness is in the region of 3.9 mm to 8.1 mm. Optionally, the first wall thickness is in the region of 5.2 mm.

Optionally, the expandable member comprises a base portion located at an opposite end of the main body portion to the neck portion, the base portion comprising a third width, the third width greater than the second width. By providing the expandable member with a base portion wider than the main body portion, the base portion may be more likely to be encouraged to move toward a periphery of a base of the receptacle upon expansion of the expandable member when compared with, for example, an expandable member comprising a main body portion and a base portion of the same width. This may ensure that the expandable member is able to contact regions of the periphery of the base of the receptacle with sufficient pressure to ensure sufficient compaction of the material from which the receptacle is made.

For an expandable member comprising a main body portion and a base portion of the same width, in use the expandable member may first contact the base of the receptacle, creating friction that hinders subsequent expansion of the expansion member toward the periphery of the base of the receptacle. As a result, the periphery of the receptacle may be insufficiently compacted, and therefore a weak spot in the finished receptacle may occur. The internal and external surface finish of the receptacle may also be unacceptably rough. Providing an expandable member with a base portion wider than the main body portion may mitigate for these factors.

Optionally, a difference between the third width and the first width is greater than the maximal thickness of the wall of the main body portion.

Optionally, the third width is in the region of 25 mm to 70 mm, for example in the region of 40 mm to 55 mm.

Optionally, the third width is no more than 10% greater than the second width, no more than 5% greater than the second width, or no more than 1% greater than the second width.

Optionally, the second width is in the region of 24 mm to 69 mm, for example in the region of 39 mm to 54 mm.

Optionally, the second width is no more than 80% greater than the first width, no more than 70% greater than the first width, no more than 60% greater than the first width, or no more than 50% greater than the first width.

Optionally, the first width is in the region of 23 mm to 68 mm, for example in the region of 38 mm to 53 mm.

Optionally, a transition region between the main body portion and the base portion comprises a region of reduced wall thickness relative to an adjacent region of the main body portion. This may encourage movement of the base portion toward the periphery of the base of the receptacle. This may be to enable movement of the base portion toward the periphery of the base of the receptacle prior to the adjacent region of the main body portion contacting, and potentially becoming frictionally engaged with, the receptacle.

Optionally, the adjacent region of the main body portion is a region of maximal wall thickness of the wall of the main body portion. Optionally, an adjacent region of the main body portion is a region of the main body portion that is within 5% of a total length of the main body portion away from the transition region.

Optionally, the base portion is rounded. Optionally, the base portion has the form of a spherical dome. Such a shape may encourage movement of the base portion toward the periphery of the base of the receptacle, for example in comparison with a base portion having a planar lower surface.

Optionally, a wall thickness of the base portion varies, and a minimal wall thickness of the base portion is located intermediate a distal most portion of the base portion from the opening and a transition region between the main body portion and the base portion. Such a minimal wall thickness location may facilitate expansion of the base portion toward a periphery of the receptacle upon expansion of the expandable member in usc.

Optionally, the base portion comprises a wall having a wall thickness substantially corresponding to the maximal thickness of the main body portion. Optionally, the base portion comprises a wall having a wall thickness less than a maximal wall thickness of the main body portion.

Optionally, the third width is no more than 1.2 times the second width. This may encourage the base portion to move toward the periphery of the base of the receptacle upon expansion of the expandable member, whilst avoiding formation of a friction lock between the base portion and the base of the receptacle.

Optionally, the expandable member comprises a monolithic component, for example such that the main body portion and the neck portion are integrally formed. For example, the expandable member may comprise a single wall structure shaped to define the various portions of the expandable member described herein.

Optionally, the expandable member comprises or is made from a resiliently deformable material. Optionally, the expandable member comprises or is made from a rubber material. Optionally, the expandable member comprises or is made from a silicone material.

Optionally, the expandable member is formed from a material comprising a Shore A hardness of between 20 and 50, for example around 40.

Optionally, shapes and dimensions of the expandable discussed above comprise shapes and dimensions of the expandable member in a partially expanded configuration, for example where sufficient fluid is contained within a hollow interior of the expandable member for the expandable member to have a defined shape without deformation of the wall structure of the expandable member.

According to a second aspect of the present invention, there is provided a receptacle moulding system comprising: a receptacle mould comprising a mould cavity for receiving a component, wherein the component is a fibre suspension or a partially formed receptacle; and the expandable member of the first aspect of the present invention, the expandable member expandable in the mould cavity so as to urge the component against an inner surface of the mould cavity during a process to form the receptacle from the component.

Optionally, the receptacle moulding system comprises an expansion fluid source fluidically connectable to the expandable member, such that expansion fluid can be selectively supplied to an interior of the expandable member when the expandable member is inserted into the mould cavity. Thus, the expandable member may be expanded when in the mould cavity in use to contact, and apply a pressure to, the fibre suspension or the partially formed receptacle held within the mould cavity.

Optionally, the receptacle moulding system comprises a heat source for supplying heat to the component when the component is held within the mould cavity. Such a system may thereby be used to provide a thermoforming process on the component when the component is held within the mould cavity.

Optionally, the receptacle moulding system comprises a bottle moulding system for moulding a bottle, for example from a fibre suspension.

Optionally, the receptacle moulding system is at least one of a fibre receptacle moulding system and a paper pulp receptacle moulding system.

According to a third aspect of the present invention, there is provided a method of moulding a receptacle, the method comprising: providing a component in a mould cavity of a mould, wherein the component is a fibre suspension or a partially formed receptacle; providing the expandable member of the first aspect of the present invention in the mould cavity; and expanding the expandable member such that relatively thin regions of the wall of the main body portion expand prior to relatively thick regions of the wall of the main body portion, and so as to urge the component against an inner surface of the mould cavity during a process to form the receptacle from the component.

By expanding the expandable member such that relatively thin regions of the wall of the main body portion expand prior to relatively thick regions of the wall of the main body portion, expansion of the main body portion of the expandable member may be controlled. For example, thinner regions of the wall may expand in preference to thicker regions of the wall. Therefore, by varying the thickness of the wall of the main body portion, contact of the main body portion with the receptacle upon expansion of the expandable member may be controlled. Such control of contact may facilitate moulding of the receptacle.

In particular, contact points of the expandable member with a receptacle may, as a result of friction, impact upon subsequent expansion of the expandable member within the receptacle. Thus, by controlling which region of the main body portion of the expandable member contacts the receptacle first, subsequent expansion and contact points of the expandable member may be controlled. This may ensure that the expandable member is able to contact particular regions of the receptacle with sufficient pressure to ensure sufficient compaction of the material from which the receptacle is made. The method may thereby provide receptacles with more uniform strength when compared with, for example, a method utilising an expandable member having a main body portion of constant thickness.

Optionally, the method comprises applying heat to component in the mould cavity. Such a method may thereby be used to provide a thermoforming process on the component when the component is held within the mould cavity.

Optionally, the method is a method of moulding at least one of a fibre receptacle and a paper pulp receptacle.

According to a fourth aspect of the present invention, there is provided a receptacle obtainable or obtained from a fabrication method comprising the method of the third aspect of the present invention.

For example, the receptacle may be obtainable or obtained from the method of the third aspect of the present invention.

Optionally, the receptacle is at least one of a fibre receptacle and a paper pulp receptacle.

The fabrication method may comprise at least one additional process. The at least one additional process may comprise coating and drying the receptacle to produce a coated receptacle. The at least one additional process may comprise applying a closure to the receptacle or the coated receptacle.

In some examples, the receptacle is a bottle.

### BRIEF DESCRIPTION OF DRAWINGS

Embodiments of the invention will now be described, by way of example only, with reference to the accompanying drawings, in which:

FIG. 1 is a schematic view of an example process for making bottles from paper pulp;

FIG. 2 is a schematic view of an example bladder for use in the example process of FIG. 1;

FIG. 3 is a schematic illustration of expansion of the example bladder of FIG. 2;

FIG. 4 is a flow diagram illustrating an example method in accordance with use of the example bladder of FIG. 2 in the example process of FIG. 1; and

FIG. 5 is a schematic enlarged view of an example of an alternative base portion of a bladder for use in the example process of FIG. 1.

### DETAILED DESCRIPTION

The following description presents exemplary embodiments and, together with the drawings, serves to explain principles of embodiments of the invention.

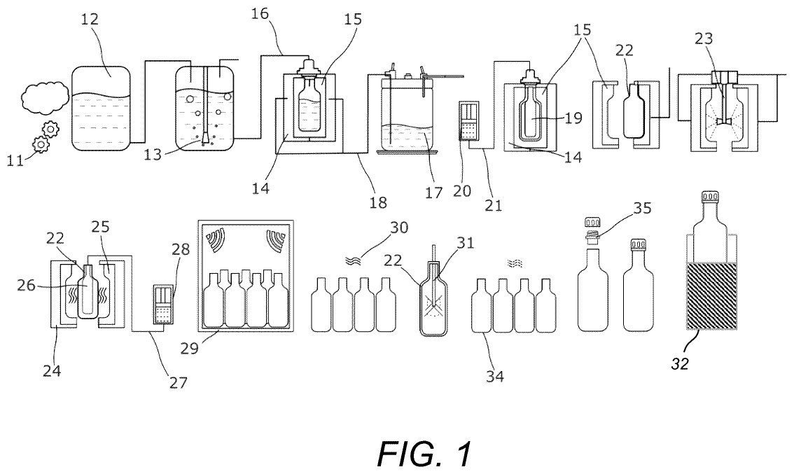

FIG. 1 shows a process for making bottles from paper pulp (i.e., which can form the basis of an example fibre suspension). The process is merely exemplary and is provided to give context to examples of the present invention. Broadly speaking, the exemplary process comprises providing a fibre suspension, introducing the fibre suspension into a mould cavity of a porous first mould and using the porous first mould to expel a liquid (such as water) from the fibre suspension to produce a wet precursor or embryo (which may itself be considered a moulded receptacle), further moulding the wet precursor in a mould to produce a further-moulded receptacle, coating the further-moulded receptacle to produce a coated moulded receptacle, drying the coated moulded receptacle to produce a dried receptacle, and applying a closure to the dried receptacle. As will be apparent at least from the following description, modifications may be made to the exemplary process to provide variants thereof in which other examples of the present invention may be embodied.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a sizing agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid In some examples, one or more additives are included in the hydrated pulp fibres after mixing the pulp fibres with the liquid (e.g. the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (e.g. a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres). In some examples, the one or more additives mixed with the processed pulp and water includes a dewatering agent, such as modified and/or unmodified polyethylene imine (PEI), e.g. modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

In this example, the porous first mould 15 comprises two half-moulds that are movable towards and away from each other, in this case using a hydraulic ram. In this example, each of the half-moulds is a monolithic or unitary tool formed by additive manufacturing (e.g. 3D-printing) that defines a mould profile, and, when the half-moulds are brought into contact with each other, their respective mould profiles cooperate to define the mould cavity in which the wet precursor or moulded receptacle is to be formed. Each half-mould may itself define a smaller moulding cavity and, when brought into cooperation with a second half-mould, the smaller moulding cavities may combine to provide the overall mould cavity. The two half-moulds may themselves be considered “splits” or “moulds” and the overall porous first mould 15 may be considered a “split-mould” or, again, a “mould”. In other examples, the porous first mould 15 may comprise more than two splits, such as three, four or six splits, that cooperate to define the moulding cavity.

In FIG. 1, the fibre suspension (also known as slurry) is top-filled into the porous mould 15, in contrast to moulding processes that dip a mould in slurry. The fibre suspension is drawn under vacuum via a line 16 and into the porous mould 15, with excess suspending liquid being drawn through the porous mould 15 under vacuum via a line 18 into a tank 17. Shot mass may be controlled by measuring (e.g., weighing) the amount of liquid drawn into the tank 17. A weight scale platform supporting the tank 17 is visible in FIG. 1. Once a required amount (e.g. a predetermined volume, such as 10 litres, or a predetermined mass, such as 10 kilograms) of liquid has been collected in the tank 17, suction of the suspending liquid through the porous mould 15 is stopped and the porous mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous mould 15 to form an embryo of the moulded receptacle.

In one form, in order to remove further suspending liquid (e.g. water) from the embryo, and form or consolidate the three-dimensional shape of the receptacle, an impermeable inflation element 19, e.g., a collapsible bladder, is inserted into the porous mould 15 and expanded to act as an internal high-pressure core structure for the porous mould 15. This process strengthens the wet embryo so that it can be handled, and displaces water from in between the fibres, thereby increasing the efficiency of a subsequent drying process. The inflation element 19 is actuated and regulated using a hydraulic pump 20. The pump 20 has a cylinder that displaces a fluid in a line 21 into the inflation element 19, to expand the inflation element 19 radially and into conformity with the mould cavity. Fluid within the line 21 is preferably non-compressible, such as water. Water also has the advantage over other non-compressible liquids that any leaking or bursting of the bladder 19 will not introduce a new substance to the system (since the suspending liquid is already water, or predominantly water).

Demoulding occurs when the porous mould 15 opens for removal of the self-supporting moulded receptacle 22. Mould cleaning 23 is preferably performed subsequently, to remove small fibres and maintain a porosity of the porous mould 15. In this example, a radially firing high-pressure jet is inserted into the mould cavity while the mould 15 is open. This dislodges fibres from the wall of the mould cavity. Alternatively, or in addition, water from the tank 17 is pressurised through the back of the porous mould 15 to dislodge entrapped fibres. Water is drained for recycling back to an upstream part of the system. It is noteworthy that cleaning is important for conditioning the porous mould 15 for re-use. The porous mould 15 may appear visibly clean after removal of the receptacle, but its performance could be compromised without cleaning.

According to FIG. 1, the formed but unfinished receptacle 22 is subsequently transported to a second moulding station where, in a, e.g., aluminium, mould 25, pressure and heat are applied for thermoforming a desired neck and surface finish, optionally including embossed and/or debossed surface features. After two halves of the mould 25 have closed around the receptacle 22, a pressuriser is engaged. For example, a bladder 26 (e.g., a thermoforming bladder 26) is inserted into the receptacle 22. The bladder 26 is inflated via a line 27 by a pump 28 to supply pressurised fluid, e.g., air, water, or oil. Optionally, during supply, the pressurised fluid is heated with e.g. a heater or, alternatively, is cooled with e.g. a heat exchanger. An external mould block 24 of the mould 25, and/or the mould 25 itself, may also, or alternatively, be heated. A state of the moulded receptacle 22 after thermoforming is considerably more rigid, with more compressed side walls, compared with the state at demoulding from the porous mould 15.

A drying stage 29 (e.g. a microwave drying process or other drying process) is performed downstream of the thermoforming, as shown. In one example, the drying stage 29 is performed before thermoforming. However, moulding in the mould 25 requires some water content to assist with bonding during the compression process. FIG. 1 illustrates a further drying stage 30 after the drying stage 29, which may utilise hot air circulated onto the moulded receptacle 22, e.g., in a “hot box”. In some examples, microwave or other drying processes may be performed at plural stages of the overall manufacturing process.

The moulded receptacle 22 is then subjected to a coating stage during which, in this example, a spray lance 31 is inserted into the moulded receptacle 22 and applies one or more surface coatings to internal walls of the moulded receptacle 22. In another example, the moulded receptacle 22 is instead filled with a liquid that coats the internal walls of the moulded receptacle 22. In practice, such coatings provide a protective layer to prevent egress of contents into the bottle wall, which may permeate and/or weaken it. Coatings will be selected dependent on the intended contents of receptacle 22, e.g., a beverage, detergent, pharmaceutical product, etc. In some examples, the further drying stage 30 is performed after the coating stage (or both before and after the coating stage). In this example, the moulded receptacle 22 is then subjected to a curing process 34, which can be configured or optimised dependent on the coating, e.g., drying for twenty-four hours at ambient conditions or by a flash drying method. In some examples, e.g. where the further drying stage 30 occurs after the coating stage, the curing process 34 may be omitted.

At an appropriate stage of production (e.g., during thermoforming, or before or after coating) a closure or mouth forming process may be performed on the moulded receptacle 22. For example, as shown in FIG. 1, a neck fitment 35 may be affixed. In some examples, an exterior coating is applied to the moulded receptacle 22, as shown in the further coating stage 32. In one example, the moulded receptacle 22 is dipped into a liquid that coats its outer surface, as shown in FIG. 1. One or more further drying or curing processes may then be performed. For example, the moulded receptacle 22 may be allowed to dry in warm air. The moulded receptacle 22 may therefore be fully formed and ready to accept contents therein.

In the example process of FIG. 1, the bladder 19 is used to urge the fibre suspension, in the form of the wet embryo, into contact with the porous mould 15, and the thermoforming bladder 26 is used to urge the unfinished receptacle 22, which may be considered a partially formed receptacle, into contact with the aluminium mould 25. In such a manner a pressing force may be applied to the fibre suspension or the partially formed receptacle to further form the desired shape of the final receptacle.

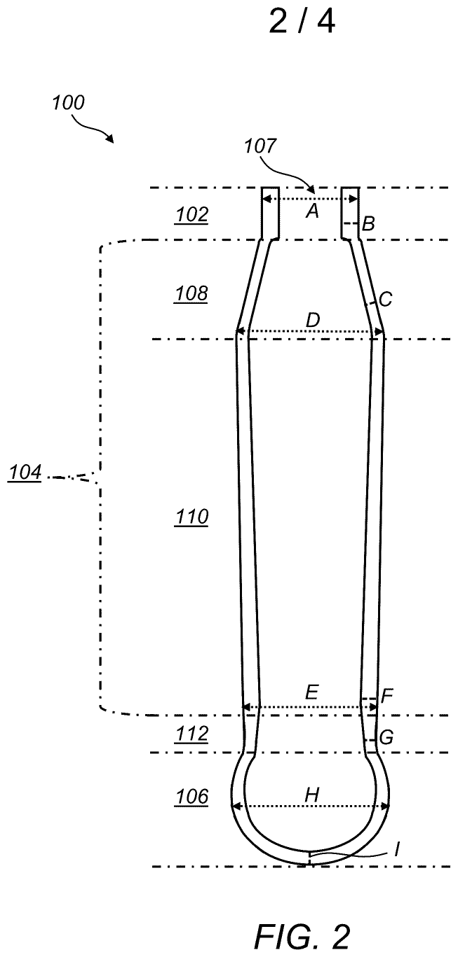

An example bladder 100 which may find utility in either of these steps of the example process of FIG. 1 is shown in cross-section in FIG. 2. Here the bladder 100 is shown supported and exposed to ambient external atmosphere, for example with substantially no radially inward or outward pressure applied to the bladder 100.

The bladder 100 is a one-piece construction, formed of silicone having a Shore A hardness in the region of 40, and is substantially hollow. The bladder 100 has a neck portion 102, a main body portion 104, and a base portion 106. The neck portion 100 is generally cylindrical in form and defines an opening 107 into the interior of the bladder. The neck portion 102 has a maximal width A, measured between two opposing, diametrically opposite, points on an outer surface of the neck portion 102, of around 30 mm, and has a substantially constant wall thickness B of around 5.2 mm.

The main body portion 104 begins at an opposite end of the neck portion 102 to the opening 107, and includes a shoulder portion 108 proximal to the neck portion 102, and a lower portion 110 distal from the neck portion 102. The shoulder portion 108 flares outwardly from the neck portion 102, and has a substantially constant wall thickness C of around 2.7 mm. The interface between the shoulder portion 108 and the lower portion 110 occurs at a point of maximal width D of the main body portion 104. The maximal width D of the main body portion 104, measured between two opposing, diametrically opposite, points on an outer surface of the main body portion 104, is around 43 mm.

The lower portion 110 tapers inwardly from the maximal width D of the main body portion 104 toward the base portion 106. A minimal width E of the lower portion 110, measured between two opposing, diametrically opposite, points on an outer surface of the lower portion 108, is around 40 mm. A wall thickness of the lower portion 110 increases gradually, without a step-change in thickness, along the length of the lower portion 110, from the wall thickness C of the shoulder portion 108 of 2.7 mm, to a maximal wall thickness F of the main body portion 104 of around 4.4 mm. The maximal thickness F of the main body portion 104 occurs at a distal most end of the main body portion 104 from the neck portion 102. Thus, the wall thickness of the main body portion 104 increases along its length from the minimal wall thickness C of the shoulder portion 108 of around 2.7 mm, to the maximal wall thickness F of the lower portion 110 of around 4.4 mm.

A transition region 112 between the lower portion 110 and the base portion 106 has a reduced wall thickness G, relative to the maximal wall thickness F of the lower portion 110, of around 3 mm.

The base portion 106 has the form of a spherical dome located at an opposite end of the main body portion 104 to the neck portion 102, such that the main body portion 104 lies intermediate the neck portion 102 and the base portion 106. The base portion 106 has a maximal width H, measured between two opposing points on an outer surface of the base portion 106, of around 44 mm. This may be considered a maximal width of the bladder 100 as a whole, in this particular stage of inflation. The base portion 106 has a substantially constant wall thickness I of around 4 mm.

In use, the bladder 100 is, for example, utilised as the thermoforming bladder 26, and is inserted into the unfinished receptacle 22, i.e. a partially formed receptacle, held within the aluminium mould 25.

The bladder 26 is inflated via the line 27 by the pump 28 to supply pressurised fluid, e.g., air, water, or oil, to the interior of the bladder 26, such that the bladder 26 expands to apply a pressing force to the unfinished receptacle 22 as part of a thermoforming process.

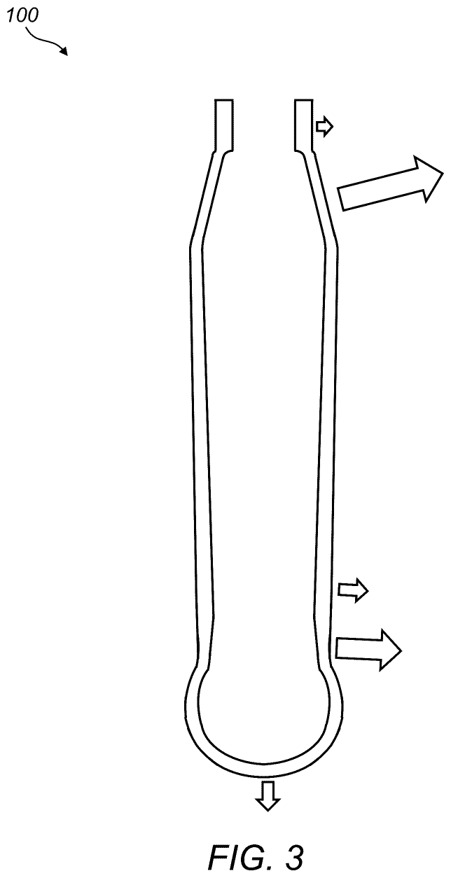

As the main body portion 104 has a wall thickness that varies along a length of the wall, expansion of the main body portion 104 of the bladder 100 is controlled such that, upon inflation, thinner regions of the wall expand in preference to thicker regions of the wall. Therefore, by varying the thickness of the wall of the main body portion 104, contact of the main body portion 104 with the unfinished receptacle upon expansion of the bladder 100 is controlled. In the example of FIG. 2, the relatively thin shoulder portion 108 of the wall expands prior to expansion of the relatively thick lower portion 110 of the wall, such that the shoulder portion 108 of the wall contacts the unfinished receptacle 22 prior to the lower portion 110 of the wall contacting the unfinished receptacle 22. Such expansion is illustrated schematically in FIG. 3 via arrows, with relative sizing of arrows used to indicate likelihood of expansion, and larger arrows indicating those regions likely to expand first.

By controlling such an initial contact point of the main body portion 104 with the unfinished receptacle 22, subsequent expansion of the bladder 100 within the unfinished receptacle 22 can be controlled. In particular, with the bladder 100 of the example of FIG. 2 it has been found that on inflation the shoulder portion 108 can expand initially to come into contact with a corresponding shoulder portion of the unfinished receptacle 22, with the remainder of the main body portion 104, and indeed the base portion 106, then subsequently expanding to fill the unfinished receptacle 22. This may ensure that the bladder is able to contact the unfinished receptacle 22 with sufficient pressure to ensure sufficient compaction of the material of the unfinished receptacle 22.

The bladder 100 may thereby provide receptacles with greater, and possibly more uniform, strength when compared to, for example, receptacles formed by use of an expandable member having a main body portion of constant thickness.

By having a relatively thick further wall portion of the neck portion 102 in comparison with the wall of the main body portion 104, increased strength may be provided in the region of the opening 107 of the bladder 100, where the bladder is connectable to the line 27 in use. A relatively thick further wall portion of the neck portion 102 in comparison to the wall of the main body portion 104 may also encourage expansion of the main body portion 104 in preference to the neck portion 102. This may be beneficial where the main body portion 104 has a width greater than the neck portion 102, as is the case for most receptacles in the form of bottles, as less expansion of the neck portion 102 is required to achieve desired compaction.

Furthermore, the maximal width H of the base portion 106 is greater than the maximal width D of the main body portion 104, and indeed the maximal width A of the neck portion 102. This means the base portion 106 may be more likely to be encouraged to move toward a periphery of a base of the unfinished receptacle 22 upon expansion of the bladder 100 when compared to, for example, a bladder having a main body portion and a base portion of the same width. This may ensure that the bladder 100 is able to contact regions of the periphery of the base of the unfinished receptacle 22 with sufficient pressure to ensure sufficient compaction of the unfinished receptacle.

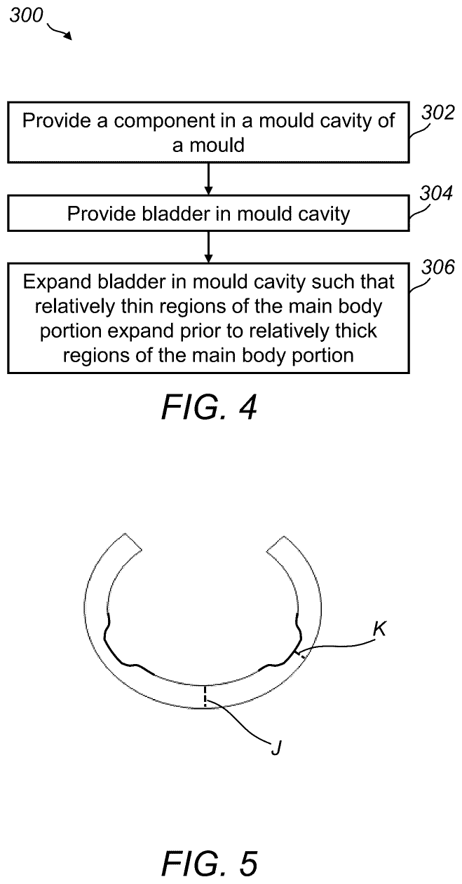

An example method 300 in accordance with use of the example bladder 100 of FIG. 2 in the example process of FIG. 1 is illustrated in the flow diagram of FIG. 4. The method 300 includes providing 302 a component in a mould cavity of a mould, wherein the component is a fibre suspension or a partially formed receptacle. The method 300 includes providing 304 the bladder 100 in the mould cavity. The method 300 includes expanding 306 the bladder 100 such that relatively thin regions of the wall of the main body portion 104 expand prior to relatively thick regions of the wall of the main body portion 104, and so as to urge the component against an inner surface of the mould cavity during a process to form a receptacle from the component.

Whilst described above in relation to the unfinished receptacle 22, it will be appreciated that the bladder 100 of the example of FIG. 2 may also be utilised to apply pressure to the wet embryo in the manner previously described.

It will also be appreciated that a bladder in which the wall thickness of the main body portion 104 varies along its length is envisaged absent the feature of the maximal width H of the base portion being greater than the maximal width D of the main body portion 104 are envisaged, and vice versa.

Furthermore, although the bladder 100 in the example of FIG. 2, has been described as having particular dimensions, it will be appreciated that the teachings herein may be equally applicable to bladders having other dimensions.

For example, bladders where the wall thickness F of the lower portion 110 is in the region of 1.2 to 2.0 times, 1.4 to 1.8 times, and around 1.6 times, the wall thickness C of the shoulder portion 108 are envisaged. Bladders where the wall thickness C of the shoulder portion 108 are in the region of 1.2 mm to 4.0 mm, in the region of 1.5 mm to 3.0 mm, and around 2.7 mm, are envisaged. Bladders where the wall thickness F of the lower portion 110 are in the region of 1.7 mm to 7.2 mm, in the region of 2.1 mm to 5.4 mm, and around 4.4 mm, are envisaged.

Bladders where the wall thickness B of the neck portion 102 is in the region of 1.1 to 1.5 times, and around 1.2 times, the wall thickness F of the lower portion 110 are envisaged. Bladders where the wall thickness B of the neck portion 102 are in the region of 3.1 mm to 10.8 mm, in the region of 3.9 mm to 8.1 mm, and around 5.2 mm, are envisaged.

Bladders where the maximal width H of the base portion are no more than 10% greater, no more than 5% greater, or no more than 1% greater, than the maximal width D of the main body portion 104 are envisaged. Bladders where the maximal width H of the base portion is in the region of 25 mm to 70 mm, for example in the region of 40 mm to 55 mm, are envisaged. Bladders where the maximal width D of the main body portion 104 is in the region of 24 mm to 69 mm, for example in the region of 39 mm to 54 mm, are envisaged.

Bladders where the maximal width D of the main body portion 104 is no more than 80% greater, no more than 70% greater, no more than 60% greater, or no more than 50% greater, than the maximal width A of the neck portion 102 are envisaged. Bladders where the maximal width A of the neck portion 102 is in the region of 23 mm to 68 mm, for example in the region of 38 mm to 53 mm, are envisaged.

Other variations in which wall thickness of portions of the bladder 100 vary are also envisaged. One such example is illustrated in FIG. 5, where the base portion has a maximal thickness J in a region corresponding to a base of the unfinished receptacle 22, for example a region distalmost to the opening 107, and a minimal wall thickness K in a region of the base portion 106 corresponding to a periphery of the base of the unfinished receptacle 22. Providing such a region of minimal wall thickness of the base portion 106 in what effectively amounts to a corner of the base portion 106 may encourage expansion of the bladder 100 to fill regions corresponding to corners, or a join between a side wall and a base, of the unfinished receptacle 22, to enable a sufficient compaction force to be applied to such regions of the unfinished receptacle 22.

Example embodiments of the present invention have been discussed, with reference to the examples illustrated. However, it will be appreciated that variations and modifications may be made without departing from the scope of the invention as defined by the appended claims.

What is claimed is:

1. An expandable member for use in moulding a receptacle in a cavity of a mould, the expandable member comprising:
a neck portion defining an opening of the expandable member, the neck portion having a first width; and
a main body portion having a second width different to the first width;
wherein the main body portion comprises a wall having a thickness that varies along a length of the wall.

2. The expandable member of claim 1, wherein the thickness of the wall varies gradually along the length of the wall.

3. The expandable member of claim 1, wherein the main body portion comprises a shoulder portion proximal to the neck portion and a lower portion distal from the neck portion, the shoulder portion having a first wall thickness, the lower portion having a second wall thickness greater than the first wall thickness.

4. The expandable member of claim 3, wherein the second wall thickness is between 1.2 and 2.0 times the first wall thickness.

5. The expandable member of claim 1, wherein the neck portion comprises a further wall portion having a further wall thickness greater than a maximal wall thickness of the wall of the main body portion.

6. The expandable member of claim 1, wherein the expandable member comprises a base portion located at an opposite end of the main body portion to the neck portion, the base portion comprising a third width, the third width greater than the second width.

7. The expandable member of claim 6, wherein a transition region between the main body portion and the base portion comprises a region of reduced wall thickness relative to an adjacent region of the main body portion.

8. The expandable member of claim 6, wherein the base portion is rounded.

9. The expandable member of claim 6 wherein a wall thickness of the base portion varies, and a minimal wall thickness of the base portion is located intermediate a distalmost most portion of the base portion from the opening and a transition region between the main body portion and the base portion.

10. A receptacle moulding system comprising:
a receptacle mould comprising a mould cavity for receiving a component, wherein the component is a fibre suspension or a partially formed receptacle; and
an expandable member expandable in the mould cavity so as to urge the component against an inner surface of the mould cavity during a process to form the receptacle from the component, the expandable member comprising:
a neck portion defining an opening of the expandable member, the neck portion having a first width, and
a main body portion having a second width different to the first width, wherein the main body portion comprises a wall having a thickness that varies along a length of the wall.

11. The receptacle moulding system of claim 10, wherein the receptacle moulding system comprises an expansion fluid source fluidically connectable to the expandable member, such that expansion fluid can be selectively supplied to an interior of the expandable member when the expandable member is inserted into the mould cavity.

12. The receptacle moulding system of claim 10, wherein the receptacle moulding system comprises a heat source for supplying heat to the component when the component is held within the mould cavity.

13. The receptacle moulding system of claim 10, wherein the receptacle moulding system is at least one of a fibre receptacle moulding system and a paper pulp receptacle moulding system.

14. A method of moulding a receptacle, the method comprising:
providing a component in a mould cavity of a mould, wherein the component is a fibre suspension or a partially formed receptacle;
providing an expandable member in the mould cavity, the expandable member comprising:
a neck portion defining an opening of the expandable member, the neck portion having a first width, and
a main body portion having a second width different to the first width, wherein the main body portion comprises a wall having a thickness that varies along a length of the wall; and
expanding the expandable member such that relatively thin regions of the wall of the main body portion expand prior to relatively thick regions of the wall of the main body portion, and so as to urge the component against an inner surface of the mould cavity during a process to form the receptacle from the component.

15. The method of claim 14, comprising applying heat to component in the mould cavity.

16. The method of claim 14, wherein the method is a method of moulding at least one of a fibre receptacle and a paper pulp receptacle.

17. A receptacle produced by a process comprising:
providing a component in a mould cavity of a mould, wherein the component is a fibre suspension or a partially formed receptacle;
providing an expandable member in the mould cavity, the expandable member comprising:
a neck portion defining an opening of the expandable member, the neck portion having a first width, and
a main body portion having a second width different to the first width, wherein the main body portion comprises a wall having a thickness that varies along a length of the wall; and
expanding the expandable member such that relatively thin regions of the wall of the main body portion expand prior to relatively thick regions of the wall of the main body portion, and so as to urge the component against an inner surface of the mould cavity during a process to form the receptacle from the component.

18. The receptacle of claim 17, wherein the receptacle is at least one of a fibre receptacle and a paper pulp receptacle.
